(19) United States
(12) Patent Application Publication
(10) Pub. No.: US 2025/0051547 A1
(43) Pub. Date: Feb. 13, 2025

(54) ANTIMICROBIAL COMPOSITIONS WITH ENHANCED EFFICACY AND PROLONGED PERFORMANCE LIFETIME, AND PREPARATION METHOD THEREOF

(71) Applicant: Nano and Advanced Materials Institute Limited, Hong Kong (CN)

(72) Inventors: Wenjun MENG, Hong Kong (CN); Shengchang TANG, Hong Kong (CN); Jihan YI, Hong Kong (CN); Mingyu ZHANG, Hong Kong (CN); Wai Hong YU, Hong Kong (CN); Sze Wing WONG, Hong Kong (CN)

(21) Appl. No.: 18/722,867

(22) PCT Filed: Jan. 28, 2023
(86) PCT No.: PCT/CN2023/073514

§ 371 Date: Jun. 21, 2024

Related U.S. Application Data
(60) Provisional application No. 63/304,148, filed on Jan. 28, 2022.

(51) Int. Cl. C08K 5/31; C08K 5/053; C08K 5/11; C08K 5/19; C08L 23/12

(52) U.S. Cl. CPC C08K 5/31; C08K 5/053; C08K 5/11; C08K 5/19; C08L 23/12

(57) ABSTRACT

Provided herein are antimicrobial polymer compositions and antimicrobial coating formulations useful for preparing antimicrobial substrates and imparting antimicrobial properties to surfaces, and methods for their use and preparation thereof.

### CROSS-REFERENCE TO RELATED APPLICATIONS

The present application claims priority from U.S. Provisional Patent Application No. 63/304,148, filed on Jan. 28, 2022, which is hereby incorporated by reference in its entirety.

### TECHNICAL FIELD

The present disclosure generally relates to the field of antimicrobial materials. More particularly, provided herein are antimicrobial compositions, such as antimicrobial polymer composites and antimicrobial coating formulations, useful for preparing antimicrobial substrates and imparting antimicrobial properties to surfaces, and methods for their use and preparation thereof.

### BACKGROUND

Pathogenic microorganisms, such as bacteria and viruses may cause infectious diseases, which not only threaten the health of individuals, but also create negative social and economic impacts felt immensely by the community at large.

Over the years, antimicrobial polymer composites have been developed that exhibit long-term antimicrobial protection and capable of reducing cross-infection. These antimicrobial polymer composites generally rely on biocides that deactivate infectious microorganisms. According to their mechanisms of action, antimicrobial products can be divided into two categories, namely, chemical killing and physical killing.

Products based on chemical or release killing store biocides, for instance silver and their derivatives, in bulk materials or coatings for a slow, gradual release to achieve an antimicrobial effect (FIG. 1). The leached biocides may interfere with microbes' metabolism or cause their structural damage. Despite wide application, chemical killing is a temporary antimicrobial solution due to the inevitable depletion of active ingredients in the polymer composite. Furthermore, biocides may cause toxicity to humans and promote the development of drug-resistant superbugs.

In the second category, physical or contact killing, biocides are bound onto the surface of the polymer composite to give the material contact-active antibacterial activity (FIG. 1). Active ingredients, such as quaternary ammonium compounds (QACs), are able to physically disrupt bacterial cell membrane or viral envelop. The non-leaching nature of this strategy ensures contact-safety and avoids development of drug-resistant superbugs. However, these biocides are often not thermally stable, thus preventing their applications in built-in processing. Furthermore, the accumulation of bacterial and viral debris eventually blocks the contact-active surface, causing a decrease in antimicrobial activity over long-term use.

Therefore, it is highly desirable to develop next generation antimicrobial materials that address or overcome at least some of the aforementioned disadvantages SUMMARY

Provided herein are antimicrobial composites and coating formulations that are highly effective against a board spectrum of infectious bacteria and viruses, yet are non-toxic, safe to use, and not conducive to drug-resistant microorganisms. The antimicrobial composites and coating formulations described herein can maintain their antimicrobial efficacy over a long period of time. Moreover, the antimicrobial composites and coating formulations possess the required chemical and physical compatibility, as well as thermal stability, to ensure successful incorporation into existing products. Finally, the manufacturing of the antimicrobial composites and coating formulations described herein is facile and scalable.

As discussed in detail below, the same loading of antimicrobials, formulations with antifouling additives can (1) unexpectedly achieve a higher antimicrobial efficacy, especially when evaluated under short time; and (2) sustain the antimicrobial function under repeated challenges of microbes. The use of processing aids can facilitate the migration of both antifouling and antimicrobial additives to the article surface.

In a first aspect, provided herein is an antimicrobial polymer composite comprising: an antimicrobial agent, an antifouling agent, and a base polymer, wherein the antifouling agent has bacteria-repellent properties.

In certain embodiments, the antifouling agent is non-biocidal.

In certain embodiments, the antifouling agent is a polyether.

In certain embodiments, the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, a polyglycerol, a poloxamer, an ethoxylated cetearyl alcohol, a polyethylene glycol diester of stearic acid and combinations thereof.

In certain embodiments, the antimicrobial agent is a quaternary ammonium compound, a quaternary phosphonium compound, a poly-quaternary ammonium compound, a poly-quaternary phosphonium compound, a polyalkyl guanidinium salt, a polyalkyl guanidine, or a combination thereof.

In certain embodiments, the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

In certain embodiments, the antimicrobial agent is R₄Y⁺X⁻, wherein Y is phosphorus or nitrogen; R for each instance is independently selected from the group consisting of alkyl and aryl; and X is an anion.

In certain embodiments, the antimicrobial agent has the Formula 1:

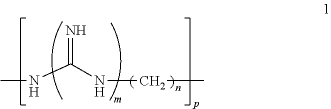

or a conjugate salt thereof, wherein
m is 1, 2, or 3;
n is a whole number selected from 2-12; and
p is a whole number selected from 2-12.

In certain embodiments, the antimicrobial agent is a polyhexamethylene guanidine (PHMG), a polyhexamethylene biguanidine (PHMB), a C₄-C₁₄ alkyl(triphenyl)phosphonium halide, a C₄-C₁₄ tetraalkylphosphonium halide, a dimethyloctadecyl[3-(trimethoxysilyl)propyl]ammonium halide, a diallyl dimethyl ammonium halide, or a mixture thereof.

In certain embodiments, the base polymer is selected from the group consisting of a polyvinyl chloride, polyolefin, polyether, polyvinyl, polyester, polyacetal, polyamide, polyurethane, polyacrylate, polycarbonate, polyimide, polyphthalate, polysulfone, polythioether, polyketone, acrylonitrile butadiene styrene, ethylene vinyl acetate, and mixtures thereof.

In certain embodiments, the base polymer is a polyolefin, a polyester, a polyvinyl chloride, or mixture thereof.

In certain embodiments, the antifouling agent is a polyethylene glycol sorbitan monolaurate, a polyethylene glycol sorbitan monooleate, a poly(ethylene glycol) sorbitol hexaoleate, a polyethene-block-poly(ethylene glycol), a polyethyleneglycol, an alkyl polyethyleneglycol, a polyglycerol, an ethoxylated cetearyl alcohol, or a combination thereof; the antimicrobial agent is a quaternary ammonium compound, a quaternary phosphonium compound, a polyalkyl guanidinium salt, a polyalkyl guanidine, or a combination thereof; and the base polymer is selected from the group consisting of a polyvinyl chloride, polyolefin, polyether, polyester, polyacetal, polyamide, polyurethane, polyacrylate, polycarbonate, polyimide, polyphthalate, polysulfone, polythioether, polyketone, acrylonitrile butadiene styrene, ethylene vinyl acetate, and mixtures thereof.

In certain embodiments, the antifouling agent is a polyoxypropylenepolyoxyethylene, polyethyleneglycol, or a mixture thereof; the antimicrobial agent is a PHMG, a PHMB, a C₄-C₁₄ alkyl(triphenyl)phosphonium halide, a C₄-C₁₄ tetraalkylphosphonium halide, or a mixture thereof; and the base polymer is a polyvinyl chloride, polyolefin, or a polyester.

In certain embodiments, the antimicrobial agent and the antifouling agent are each independently present in the antimicrobial polymer composite at a concentration between about 0.1 to about 5 parts per hundred relative to the base polymer.

In certain embodiments, the antimicrobial agent and the antifouling agent are each independently present in the antimicrobial polymer composite at a concentration between about 0.5 to about 3 parts per hundred relative to the base polymer.

In certain embodiments, antimicrobial polymer composite further comprises an additive selected from the group consisting of antioxidants, brighteners, nucleating agents, mold release agents, color stabilizers, UV stabilizers, fillers, plasticizers, impact modifiers, colorants, lubricants, antistatic agents, fire retardants, processing additive, and anti-ester exchange agents.

In certain embodiments, the antimicrobial polymer composite further comprises an additive selected from the group consisting of BASF Pluronic® F127, DOW AMPLIFY™ GR216, Irganox® 1010, Lotader® AX8840, Incromax® 100, Irganox® 1076, and Irgafos® 168.

In a second aspect, provided herein is an antimicrobial coating formulation comprising: an antimicrobial agent, an antifouling agent, and a monomer, wherein the antifouling agent has bacteria-repellent properties.

In certain embodiments, the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, a polyglycerol, a poloxamer, an ethoxylated cetearyl alcohol, a polyethylene glycol diester of stearic acid and combinations thereof.

In certain embodiments, antimicrobial agent is a quaternary ammonium compound, a quaternary phosphonium compound, a polyalkyl guanidinium salt, a polyalkyl guanidine, or a combination thereof.

In certain embodiments, the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

In certain embodiments, the antimicrobial agent is R₄P⁺X⁻, wherein R for each instance is independently selected from the group consisting of alkyl and aryl; and X is an anion.

In certain embodiments, the antimicrobial agent has the Formula 1:

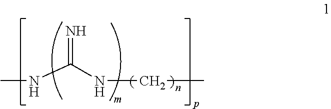

or a conjugate salt thereof, wherein
m is 1, 2, or 3;
n is a whole number selected from 2-12; and
p is a whole number selected from 2-12.

The antimicrobial coating formulation of claim 18, wherein the antimicrobial agent is a polyhexamethylene guanidine (PHMG), a polyhexamethylene biguanidine (PHMB), a C₄-C₁₄ alkyl(triphenyl)phosphonium halide, a C₄-C₁₄ tetraalkylphosphonium halide, a dimethyloctadecyl[3-(trimethoxysilyl)propyl]ammonium halide, a diallyl dimethyl ammonium halide, or a mixture thereof.

In certain embodiments, the monomer is selected from the group consisting of an alkyl acrylate, an alkyl methacrylate, acrylic acid, methacrylic acid, an epoxy resin, and a mixture thereof.

In certain embodiments, the monomer is methacrylic acid, an epoxy resin, or a mixture thereof.

In certain embodiments, the antifouling agent is a polyethylene glycol sorbitan monolaurate, a polyethylene glycol sorbitan monooleate, a poly(ethylene glycol) sorbitol hexaoleate, a polyethene-block-poly(ethylene glycol), a polyethyleneglycol, an alkyl polyethyleneglycol, a polyglycerol, an ethoxylated cetearyl alcohol, or a combination thereof; the antimicrobial agent is a quaternary ammonium compound, a quaternary phosphonium compound, a polyalkyl guanidinium salt, a polyalkyl guanidine, or a combination thereof; and the monomer is selected from the group consisting of an alkyl acrylate, an alkyl methacrylate, acrylic acid, methacrylic acid, an epoxy resin, and a mixture thereof.

In certain embodiments, the antifouling agent is a polyethyleneglycol; the antimicrobial agent is a dimethyloctadecyl[3-(trimethoxysilyl)propyl]ammonium halide, a diallyl dimethyl ammonium halide or a mixture thereof; and the monomer is acrylic acid, methacrylic acid, an epoxy resin, or a mixture thereof.

In certain embodiments, the antimicrobial agent and the antifouling agent are each independently present in the antimicrobial polymer composite at a concentration between about 1 to about 10 parts per hundred relative to the base polymer.

In certain embodiments, the antimicrobial agent and the antifouling agent are each independently present in the antimicrobial polymer composite at a concentration between about 2 to about 10 parts per hundred relative to the base polymer.

In a third aspect, provided herein is a method of applying the antimicrobial coating formulation described herein to a substrate, the method comprising: depositing the antimicrobial coating formulation on a surface of the substrate thereby forming a coated substrate and optionally curing the coated substrate.

In certain embodiments, the step of curing comprises at least one method selected from the group consisting of heating the coated substrate at a temperature between 30-200° C.; and irradiating the coated substrate with ultraviolet radiation.

In a fourth aspect, provided herein is a sprayable antimicrobial coating formulation comprising: an antimicrobial agent, an antifouling agent, a film forming agent, and a solvent, wherein the antifouling agent has bacteria-repellent properties.

In certain embodiments, the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, an alkoxy polyethyleneglycol, an alkoxy polyethyleneglycol alkyltrialkoxysilane, a polyglycerol, a poloxamer, an ethoxylated cetearyl alcohol, a polyethylene glycol diester of stearic acid and combinations thereof.

In certain embodiments, the antimicrobial agent is a quaternary ammonium compound, a quaternary phosphonium compound, a poly-quaternary ammonium compound, a poly-quaternary phosphonium compound, a polyalkyl guanidinium salt, a polyalkyl guanidine, a polyethyleneimine, or a combination thereof.

In certain embodiments, the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

In certain embodiments, the antimicrobial agent has the Formula 1:

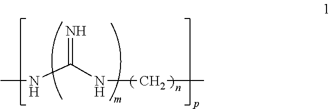

or a conjugate salt thereof, wherein
m is 1, 2, or 3;
n is a whole number selected from 2-12; and
p is a whole number selected from 2-12.

In certain embodiments, the antimicrobial agent is a polyhexamethylene guanidine (PHMG), a polyhexamethylene biguanidine (PHMB), dimethyloctadecyl[3-(trimethoxysilyl)propyl]ammonium halide, a diallyl dimethyl ammonium halide, a branched polyethylenimine, or a mixture thereof.

In certain embodiments, the film forming agent is selected from the group consisting of polyvinyl alcohol, polyvinyl pyrrolidone, polyacrylic acid, polyacrylamide, polymethacrylamide, polyethylene oxide, polyalkyl vinyl ether, polyurethane, carboxymethylcellulose, methylcellulose, hydroxypropylcellulose, chitosan, sodium alginate, and mixtures and copolymers thereof.

In certain embodiments, the film forming agent comprises polyvinyl pyrrolidone.

In certain embodiments, the antifouling agent is a polyethyleneglycol, an alkyl polyethyleneglycol, an alkoxy polyethyleneglycol, an alkoxy polyethyleneglycol alkyltrialkoxysilane, or a combination thereof; the antimicrobial agent is a quaternary ammonium compound, polyalkyl guanidinium salt, a polyalkyl guanidine, a branched polyethylenimine, or a combination thereof; and the film forming agent is polyvinyl pyrrolidone.

In certain embodiments, the antifouling agent is an alkyl polyethyleneglycol, an alkoxy polyethyleneglycol alkyltrialkoxysilane, or a combination thereof; the antimicrobial agent is a dimethyloctadecyl[3-(trimethoxysilyl)propyl]ammonium halide, a diallyl dimethyl ammonium halide, polyhexamethylene biguanide, a branched polyethylenimine, or a mixture thereof; and the film forming agent is polyvinyl pyrrolidone.

In certain embodiments, the antimicrobial agent and the antifouling agent are each independently present in the sprayable antimicrobial coating formulation at a concentration between about 0.1 to about 5 parts per hundred.

In certain embodiments, the film forming agent is present in the sprayable antimicrobial coating formulation at a concentration between about 0.1 and 5 parts per hundred.

In certain embodiments, the solvent comprises water, an alcohol, or a mixture thereof.

In certain embodiments, the antifouling agent is an alkyl polyethyleneglycol, an alkoxy polyethyleneglycol alkyltrialkoxysilane, or a combination thereof; the antimicrobial agent is a dimethyloctadecyl[3-(trimethoxysilyl)propyl]ammonium halide, a diallyl dimethyl ammonium halide, a polyhexamethylene biguanide, a branched polyethylenimine, or a mixture thereof; the film forming agent is polyvinyl pyrrolidone; and the solvent comprises water.

### BRIEF DESCRIPTION OF DRAWINGS

The above and other objects and features of the present disclosure will become apparent from the following description of the disclosure, when taken in conjunction with the accompanying drawings, in which:

FIG. 1 depicts a comparison of existing antimicrobial technologies with antimicrobial agents used in the present disclosure (Antifouling Germ-Spike). In the last panel, the blue “Germ-Spikes” carry positive charges capable of damaging the surface structure of pathogenic microorganisms, whose debris will then be repelled by antifouling agents to achieve a sustained antimicrobial effect.

FIG. 2 depicts chemical structures of representative quaternary phosphonium compounds (QPCs) and polymeric guanidine. Their corresponding onsets of thermal degradation temperature are above 250° C., suggesting that these modifiers are promising options for the built-in processing of plastics.

FIG. 3 depicts chemical structures of poly(ethylene glycol) based hydrophilic modifiers for prevent surface fouling.

FIG. 4 depicts Schematic illustration of a two-step manufacturing approach to prepare antimicrobial plastics via built-in processing.

FIG. 5 depicts an exemplary process for applying an antimicrobial coating to the surface of a substrate in accordance with certain embodiments described herein.

FIG. 6 depicts the antimicrobial coating formulation AGT-21 (Example 5) showed above 99.9% of antiviral activity against Human coronavirus OC43 under Standard ISO 21702.

FIG. 7 depicts the antimicrobial coating formulation EC10 (Example 7) showed above 99.9% of antiviral activity against Human coronavirus 229E under Standard ISO 21702.

FIG. 8 depicts a plastic sheet sprayed with the antimicrobial spray formulation AGD-58 prepared in Example 8, which showed above 99% antiviral activity against human coronavirus OC43 under ISO 21702.

FIG. 9 depicts a table summarizing the antimicrobial efficacies of antimicrobial coating formulations in accordance with certain embodiments described herein.

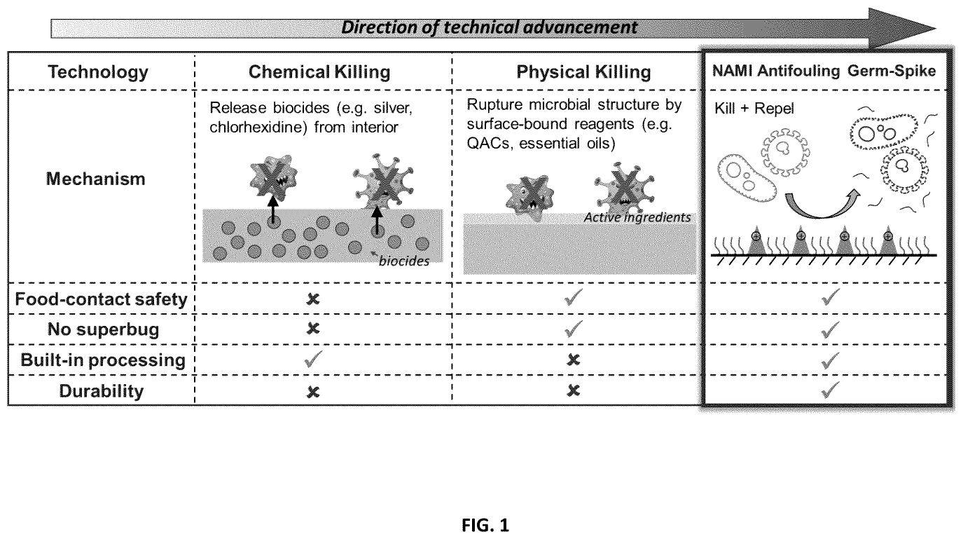

### DETAILED DESCRIPTION

References in the specification to “one embodiment”, “an embodiment”, “exemplary embodiment”, etc. mean that the described embodiment may include a particular feature, structure, or characteristic, but not every embodiment may include the specific feature, structure or characteristic. Moreover, such phrases do not necessarily refer to the same embodiment. In addition, when a specific feature, structure or characteristic is described in conjunction with a certain embodiment, no matter whether it is explicitly described or not, it is considered that the effect of applying the characteristic, structure or characteristic to other embodiments is within the scope of knowledge of those skilled in the art.

Values expressed in ranges should be interpreted in a flexible manner, including not only the values explicitly listed as the limits of the range, but also all individual values or subranges included in the range, as if each value and subrange were clearly stated. For example, a concentration range of “about 0.1% to about 5%” should be construed to include not only the explicitly listed about 0.1% to about 5% by weight, but also individual concentrations within the specified range (e.g., 1%, 2%). 3% and 4%) and sub-ranges (e.g. 0.1% to 0.5%, 1.1% to 2.2% and 3.3% to 4.4%).

As described herein, unless otherwise stated, the term “a” or “an” is used to include one or more than one, and the term “or” is used to refer to a non-exclusive “or.” In addition, when the terms or terms used herein are not otherwise defined, they should be understood as being used only for the purpose of description and not for the purpose of limitation. In addition, all publications, patents, and patent documents mentioned in the specification are incorporated herein by reference in their entirety, as if individually incorporated by reference. If the usage between this document and those documents incorporated by reference is inconsistent, the usage in the cited reference shall be considered as a supplement to this document. For irreconcilable inconsistencies, the usage in this document shall prevail.

In the manufacturing method described in the specification, the steps can be performed in any order without departing from the principle of the present invention, except that the time or operation sequence is clearly stated. It is stated in the claims that a step is performed first, and then several other steps are performed. It should be considered that the first step is performed before any other steps, and other steps can be performed in any other steps, unless in other steps the sequence is further listed in the step. For example, a claim stating “step A, step B, step C, step D, and step E” should be interpreted to mean that step A is performed first, and step E is performed last, and steps B, C, and D can be performed in steps A and E They are executed in any order, and these orders still fall within the literal scope of the process claimed by the claims. Likewise, a given step or substep can be repeated.

In addition, unless the claims clearly state that they are executed separately, the specified steps can be executed simultaneously. For example, the required step of doing X and the required step of doing Y can be performed simultaneously in a single operation, and such a process will fall within the literal scope of the claimed process.

The singular forms “a”, “an” and “the” may include plural indicators unless the context clearly dictates otherwise.

The term “about” may allow a range of values or a degree of variability within a range, for example, within 10% or 5% of a specified value or specified range of the range.

Unless the context clearly dictates otherwise, the term “independently selected from” means that the mentioned groups are the same, different, or a mixture thereof. Therefore, under this definition, “X1, X2, and X3 are independently selected from inert gases” will include the following schemes, for example, when X1, X2, and X3 are all the same, X1, X2, and X3 are completely different, where X1 and X2 are the same, But X3 is different, and other similar arrangements.

The term “alkyl” is art-recognized, and includes saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C₁-C₃₀ for straight chain, C₃-C₃₀ for branched chain), and alternatively, about 20 or fewer. Likewise, cycloalkyls have from about 3 to about 10 carbon atoms in their ring structure, and alternatively about 5, 6 or 7 carbons in the ring structure.

The term “aralkyl” is art-recognized and refers to an alkyl group substituted with an aryl group (e.g., an aromatic or heteroaromatic group).

The terms “alkenyl” and “alkynyl” are art-recognized and refer to unsaturated aliphatic groups analogous in length and possible substitution to the alkyls described above, but that contain at least one double or triple bond respectively.

The term “aryl” is art-recognized and refers to 5-, 6- and 7-membered single-ring aromatic groups that may include from zero to four heteroatoms, for example, benzene, naphthalene, anthracene, pyrene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics.” The aromatic ring may be substituted at one or more ring positions with such substituents as described above, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “aryl” also includes polycyclic ring systems having two or more cyclic rings in which two or more carbons are common to two adjoining rings (the rings are “fused rings”) wherein at least one of the rings is aromatic, e.g., the other cyclic rings may be cycloalkyls, cycloalkenyls, cycloalkynyls, aryls and/or heterocyclyls.

The term “optionally substituted” refers to a chemical group, such as alkyl, cycloalkyl aryl, and the like, wherein one or more hydrogen may be replaced with a with a substituent as described herein, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like

The term “nitro” is art-recognized and refers to NO₂; the term “halogen” is art-recognized and refers to —F, —Cl, —Br or —I; the term “sulfhydryl” is art-recognized and refers to —SH; the term “hydroxyl” means —OH; and the term “sulfonyl” is art-recognized and refers to —SO₂—. “Halide” designates the corresponding anion of the halogens, and “pseudohalide” has the definition set forth on 560 of “Advanced Inorganic Chemistry” by Cotton and Wilkinson.

The abbreviations Me, Et, Ph, Tf, Nf, Ts, and Ms represent methyl, ethyl, phenyl, trifluoromethanesulfonyl, nonafluorobutanesulfonyl, p-toluenesulfonyl and methanesulfonyl, respectively. A more comprehensive list of the abbreviations utilized by organic chemists of ordinary skill in the art appears in the first issue of each volume of the Journal of Organic Chemistry; this list is typically presented in a table entitled Standard List of Abbreviations.

Certain compounds contained in compositions of the present invention may exist in particular geometric or stereoisomeric forms. The present invention contemplates all such compounds, including E- and Z-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, or other reaction.

The term “substituted” is also contemplated to include all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, for example, those described herein above. The permissible substituents may be one or more and the same or different for appropriate organic compounds. For purposes of this invention, the heteroatoms such as nitrogen may have hydrogen substituents and/or any permissible substituents of organic compounds described herein which satisfy the valences of the heteroatoms. This invention is not intended to be limited in any manner by the permissible substituents of organic compounds.

As used herein, a “polymeric compound” (or “polymer”) refers to a molecule including a plurality of one or more repeating units connected by covalent chemical bonds.

A polymeric compound can be represented by General Formula I:

*-(-(Ma)ₓ-(Mb)_{y}-)_{z}* General Formula I
wherein each Ma and Mb is a repeating unit or monomer. The polymeric compound can have only one type of repeating unit as well as two or more types of different repeating units. When a polymeric compound has only one type of repeating unit, it can be referred to as a homopolymer. When a polymeric compound has two or more types of different repeating units, the term “copolymer” or “copolymeric compound” can be used instead. For example, a copolymeric compound can include repeating units where Ma and Mb represent two different repeating units. Unless specified otherwise, the assembly of the repeating units in the copolymer can be head-to-tail, head-to-head, or tail-to-tail. In addition, unless specified otherwise, the copolymer can be a random copolymer, an alternating copolymer, or a block copolymer. For example, General Formula I can be used to represent a copolymer of Ma and Mb having x mole fraction of Ma and y mole fraction of Mb in the copolymer, where the manner in which comonomers Ma and Mb is repeated can be alternating, random, regiorandom, regioregular, or in blocks, with up to z comonomers present. In addition to its composition, a polymeric compound can be further characterized by its degree of polymerization (n) and molar mass (e.g., number average molecular weight (M) and/or weight average molecular weight (Mw) depending on the measuring technique(s)). The polymers described herein can exist in numerous stereochemical configurations, such as isotactic, syndiotactic, atactic, or a combination thereof.

Provided herein is an antimicrobial polymer composite comprising: an antimicrobial agent, an antifouling agent, and a base polymer, wherein the antifouling agent has bacteria-repellent properties. Due to the presence of both a bacteria-repellent antifouling agent and antimicrobial agent, antimicrobial materials described herein have improved lifetimes and enhanced antimicrobial properties. In certain embodiments, the antifouling agent can be a non-biocidal agent. The antimicrobial polymer composite does not require the use of metal-based antimicrobial agents, which are susceptible to leaching out of the composite over time.

The antimicrobial polymer composites described herein comprise positively charged antimicrobial agents (or antimicrobial agents with basic functionality that can become charged) as physically killing biocides. The surfaces of bacteria and viruses are decorated with negatively charged biomacromolecules, for example, polysaccharides, phospholipids, and amino acid patches. It has been established that neutralization of these delicate negatively charged patterns, by the use of positively charged species, can lead to a permanent disruption of the microbial structure and its deactivation.

However, many existing cationic antimicrobial modifiers, especially the well-known QACs, have considerable processing limitations. Due to their insufficient thermal stabilities, these modifiers are only applicable for coating, where the processing temperature is below 200° C. However, the processing of plastic materials often encounters high temperature that goes above the melting temperature of semi-crystalline polymers (e.g., 260° C. for polyethylene terephthalate, PET) or the flow temperature of amorphous polymers to achieve appropriate viscosity (e.g., 270° C. for Tritan® copolyester). Even for varnishes or paints, thermal stability is often desirable, but remains elusive, for example, above 200° C. for 30 min under atmospheric conditions.

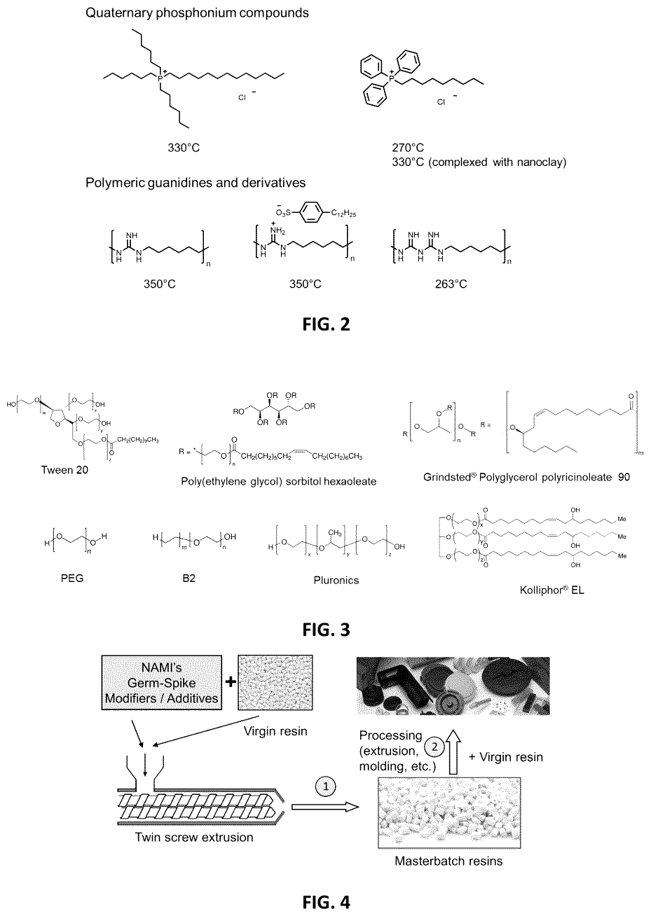

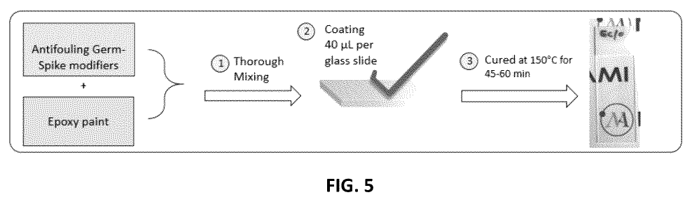

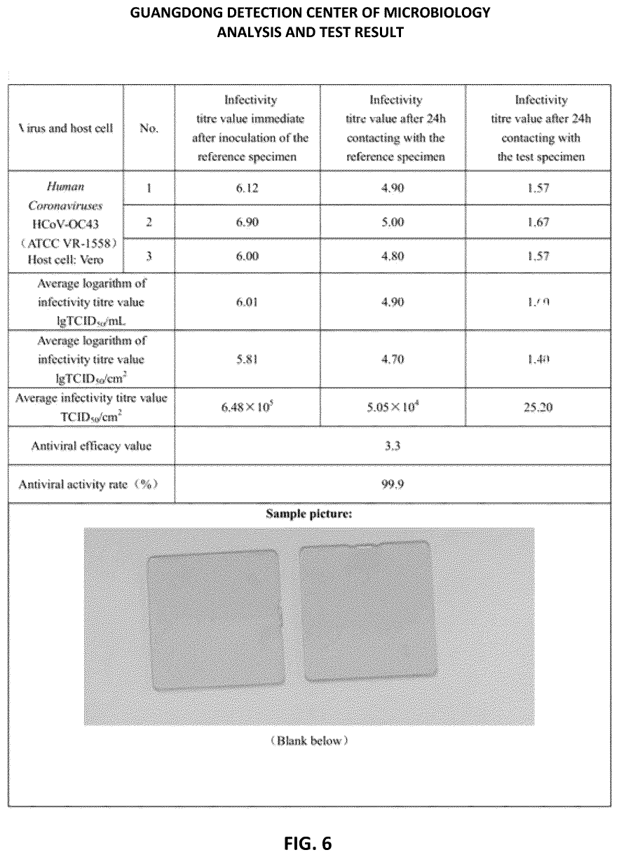

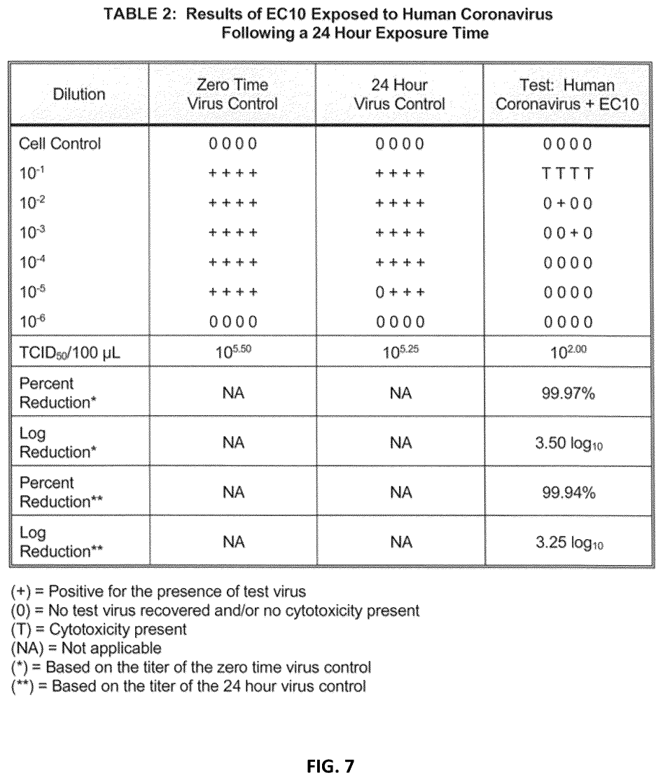

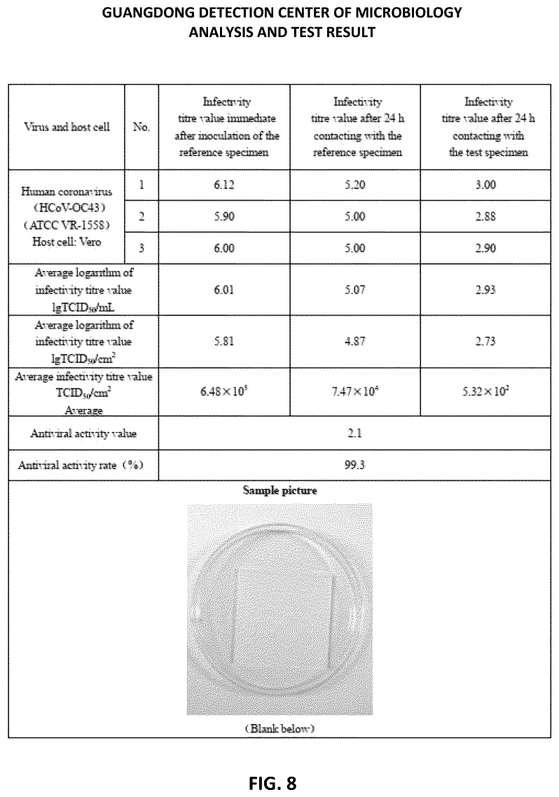

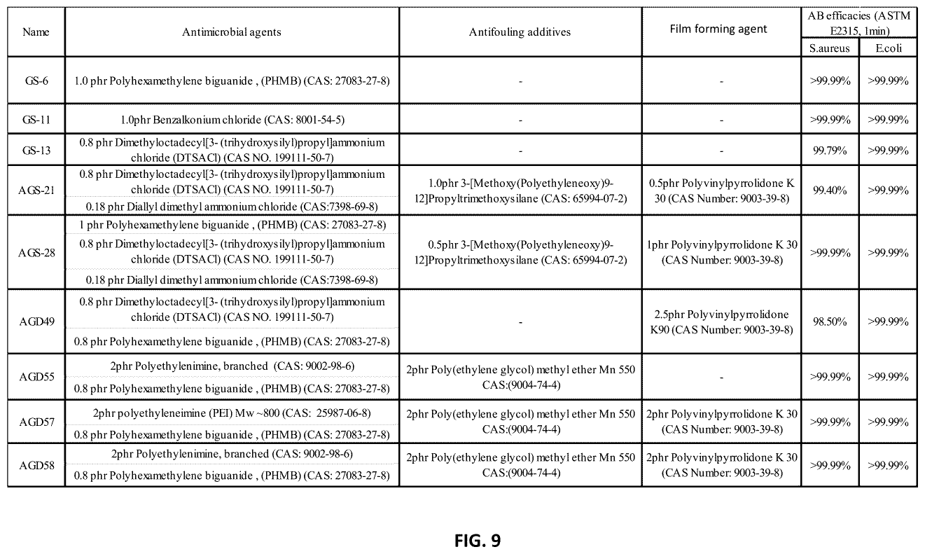

The antimicrobial compositions described herein comprise antimicrobial agents that exhibit sufficiently high thermal stability to fulfil the high-temperature processing needs. The first type of chemical is quaternary phosphonium compounds (or QPCs, FIG. 2), which have traditionally gained technical importance as phase-transfer catalysts and polyelectrolytes in batteries. Compared with their ammonium analogs, QPCs usually degrade at a temperature of 30 degrees higher. The thermal stability of QPCs can be further enhanced after complexation with fillers, such as organoclays. Moreover, QPCs can exhibit more potent antimicrobial activity: they can lead to a larger reduction of microorganism counts in a shorter time period. Without wishing to be bound by theory, it is believed that this may be due to a stronger polarization effect of the phosphorous atom.

A second type of antimicrobial agent useful in the antimicrobial polymer composites described herein are polymeric guanidines. Examples include, but are not limited to, polyhexamethylene guanidine (PHMG) and polyhexamethylene biguanidine (PHMB) (FIG. 2). Recent studies have shown that polymeric guanidines and derivatives can resist thermal degradation up to 250° C., and have been incorporated into a variety of plastics to achieve antimicrobial functions. However, they have not been used in any commercially available polymer composites.

A third type of antimicrobial agent useful in the antimicrobial polymer composites described herein are QACs. As discussed previously, QACs have low thermal stability. However, the thermal stability of QACs can be improved by the addition of a filler to the antimicrobial polymer composites. Exemplary fillers include, but are not limited to, organoclays, nanoclays, zeolites, and boron nitride platelets, and the like.

The inherent limitation of the physical killing mechanism lies in the inevitable consequence that accumulating microorganism debris blocks the contact active surfaces. Due to the non-migratory nature of the physical killing agents, once the upmost functional surface is blocked, the antimicrobial function will gradually decrease and be eventually lost. Importantly, recovery of the antimicrobial activity is only possible after harsh washing, for example, in soapy water at 50° C. for 12 h, followed by thorough rinsing with distilled water.

The antimicrobial polymer composites described herein overcome the blockage of the polymer composite surface by microorganisms by exploiting the antifouling effect of hydrophilic reagents to achieve long-term self-cleaning function. Perhaps counterintuitively and surprisingly, the presence of antifouling agents does not negate the intended antimicrobial activity. Rather, at a proper ratio of hydrophilic antifouling agents and positively charged physically killing agents, it was observed that the presence of antifouling agents better maintain the antimicrobial activities after repeated use or long-term bacterial culture. FIG. 3 shows several poly(ethylene glycol) based modifiers useful for our study.

The antifouling agent can be selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, a polyglycerol, a poloxamer, an ethoxylated cetearyl alcohol, a polyethylene glycol diester of stearic acid and combinations thereof.

Additional antifouling agents useful in the antimicrobial polymer composites described herein include fatty alcohol polyoxyalkylene ether, a polyoxyalkylene fatty acid, a polyoxyalkylene sorbitan, a polyoxyalkylene sorbitan fatty acid ester, a polyether glycol, and combinations thereof. Exemplary antifouling agents include, but are not limited to, polyoxyethylene sorbitol hexaoleate, polyoxyethylene sorbitan monolaurate, polyoxyethylene lauryl ether, polyoxyethylene hydrogenated castor oil, polyoxyethylene cetyl/octadecyl ether, allyl polyethylene glycol, methoxypolyglycol silane, polyoxyethylene acrylate, polyoxyethylene methacrylate, polyoxyethylene vinyl ether, polyoxypropylene glycol, polyoxypropylene amine, polyoxypropylene acrylate, polyoxypropylene methacrylate, polyoxypropylene glyceryl ether, and combinations thereof.

In instances in which the antifouling agent comprises a polyethylene glycol moiety, the average molecular weight of the polyethylene glycol moiety can range between about 130 to about 4,400 amu.

The antimicrobial agent can be a quaternary ammonium compound, a quaternary phosphonium compound, a polyalkyl guanidinium compound, a polyalkyl guanidine, or a combination thereof. Quaternary phosphonium compounds, polyalkyl guanidinium salts, and polyalkyl guanidines exhibit improved stability at high temperatures (See FIG. 2), as compared with quaternary ammonium compounds, allowing their compounding in the antimicrobial polymer composites described herein with minimal thermal degradation. The present disclosure also contemplates the use of poly quaternary phosphonium compounds and poly quaternary ammonium compounds in the antimicrobial polymer composites described herein. Exemplary poly quaternary phosphonium compounds and poly quaternary ammonium compounds include, but are not limited to poly(diallyldimethylammonium chloride), quaternized hydroxyethyl cellulose, copolymer of acrylamide and diallyldimethylammonium, terpolymer of acrylic acid, methacrylamidopropyl trimethylammonium chloride, and methyl acrylate, copolymer of vinylpyrrolidone and quaternized dimethylaminoethyl methacrylate, chloridepoly(diallyldiethylphosphonium chloride), and the like.

In certain embodiments, the antimicrobial agent has the chemical formula: R₄Y⁺X⁻, wherein Y is phosphorus or nitrogen; R for each instance is independently selected from the group consisting of alkyl, alkenyl, alkynyl, cycloalkyl, aryl, and aralkyl; and X is an anion. In certain embodiments, the antimicrobial agent is R₄P⁺X⁻, wherein R for each instance is independently selected from the group consisting of alkyl and aryl. The anion can be any anion known in the art including, but not limited to, chloride, bromide, iodide, nitro, biphosphate, adipate, alginate, ascorbate, aspartate, benzenesulfonate, besylate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, bisulfate, tartrate, thiocyanate, p-toluenesulfonate, undecanoate, valerate, and the like. In certain embodiments, the anion is chloride, bromide, or iodide.

In instances in which the antimicrobial agent is a polyalkyl guanidine, the antimicrobial agent can have the Formula 1:

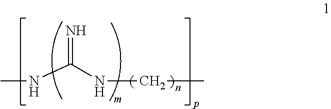

or a conjugate salt thereof, wherein
m is 1, 2, or 3;
n is a whole number selected from 2-20; and
p is a whole number selected from 2-20.

In certain embodiments, n is 2-18, 2-16, 2-14, 2-12, 4-12, 6-12, 8-12, 6-10, or 5-8.

In certain embodiments, p can be 2-18, 2-16, 2-14, 2-12, 4-12, 6-12, 8-12, or 10-12.

The average molecular weight of the polyalkyl guanidine can range between 200-800 amu.

Conjugate salts of the polyalkyl guanidine include those formed with inorganic acids, such as hydrochloric acid, hydrobromic acid, phosphoric acid, sulfuric acid and perchloric acid or with organic acids, such as acetic acid, oxalic acid, maleic acid, tartaric acid, citric acid, succinic acid or malonic acid or by using other methods used in the art such as ion exchange. Other conjugate salts include those comprising adipate, alginate, ascorbate, aspartate, benzenesulfonate, besylate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate salts, and the like. In certain embodiments, organic acids from which salts can be derived include, for example, acetic acid, propionic acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid, and the like.

The antimicrobial agent can be PHMG, PHMB, a C₄-C₁₄ alkyl(triphenyl)phosphonium halide, a C₄-C₁₄ tetraalkylphosphonium halide, a dimethyloctadecyl[3-(trimethoxysilyl)propyl]ammonium halide, a diallyl dimethyl ammonium halide, or a mixture thereof. The halide can be chloride, bromide, or iodide.

The base polymer can be selected from the group consisting of a polyvinyl chloride, polyolefin, polyether, polyvinyl, polyester, polyacetal, polyamide, polyurethane, polyacrylate, polycarbonate, polyimide, polyphthalate, polysulfone, polythioether, polyketone, acrylonitrile butadiene styrene, ethylene vinyl acetate, and mixtures thereof. In certain embodiments, the base polymer is a polyolefin, a polyester, a polyvinyl chloride, or mixture thereof. Exemplary base polymers can also include the copolyester sold under the trademark Tritan®, a polypropylene homopolymer, modified polycyclohexylenedimethylene terephthalate or PET.

Additional base polymers useful in the antimicrobial polymer composite described herein include polyurethane, styrene-ethylene-butylene-styrene block thermoplastic elastomer, polyolefin elastomer, thermoplastic polyester elastomer, polyethylene, polypropylene, polystyrene, styrene-acrylonitrile copolymer, acrylonitrile-butadiene-styrene terpolymer, terephthalic acid-tetramethylcyclobutanediol-cyclohexanediol copolymer, polylactic acid, polymethyl methacrylate, polyethylene terephthalate, polycarbonate, polymethylpentene, polyamide, polyvinyl chloride, ethylene-vinyl acetate copolymer, styrene-methacrylate-based copolymer, methyl methacrylate-butadiene-styrene terpolymer, and combinations thereof.

The antimicrobial agent can be present in the antimicrobial polymer composite at a concentration between about 0.1 to about 5 parts per hundred, about 0.1 to about 4.5 parts per hundred, about 0.1 to about 4 parts per hundred, about 0.1 to about 3.5 parts per hundred, about 0.1 to about 3 parts per hundred, about 0.5 to about 5 parts per hundred, about 1 to about 5 parts per hundred, about 1.5 to about 5 parts per hundred, about 2 to about 5 parts per hundred, about 2.5 to about 5 parts per hundred, about 3 to about 5 parts per hundred, about 3.5 to about 5 parts per hundred, about 4 to about 5 parts per hundred, about 4.5 to about 5 parts per hundred, about 1 to about 4.5 parts per hundred, about 1.5 to about 4.5 parts per hundred, about 2 to about 4 parts per hundred, or about 2.5 to about 3.5 parts per hundred relative to the base polymer.

The antifouling agent can be present in the antimicrobial polymer composite at a concentration between about 0.1 to about 5 parts per hundred, about 0.1 to about 4.5 parts per hundred, about 0.1 to about 4 parts per hundred, about 0.1 to about 3.5 parts per hundred, about 0.1 to about 3 parts per hundred, about 0.5 to about 5 parts per hundred, about 1 to about 5 parts per hundred, about 1.5 to about 5 parts per hundred, about 2 to about 5 parts per hundred, about 2.5 to about 5 parts per hundred, about 3 to about 5 parts per hundred, about 3.5 to about 5 parts per hundred, about 4 to about 5 parts per hundred, about 4.5 to about 5 parts per hundred, about 1 to about 4.5 parts per hundred, about 1.5 to about 4.5 parts per hundred, about 2 to about 4 parts per hundred, or about 2.5 to about 3.5 parts per hundred relative to the base polymer.

The antimicrobial polymer composites described herein can optionally further comprise one or more additives selected from antioxidants, brighteners, nucleating agents, mold release agents, color stabilizers, UV stabilizers, fillers, plasticizers, impact modifiers, colorants, lubricants, antistatic agents, fire retardants, and anti-ester exchange agents.

The antioxidant can be a phenol-based antioxidant. Exemplary antioxidants, include, but are not limited to, butylated hydroxytoluene, Irganox®1010, Irganox®1076, Irganox®1098, Irgafos® 168 or Irganox® B 225, and the like. In certain embodiments, the antioxidant is selected from the group consisting of:

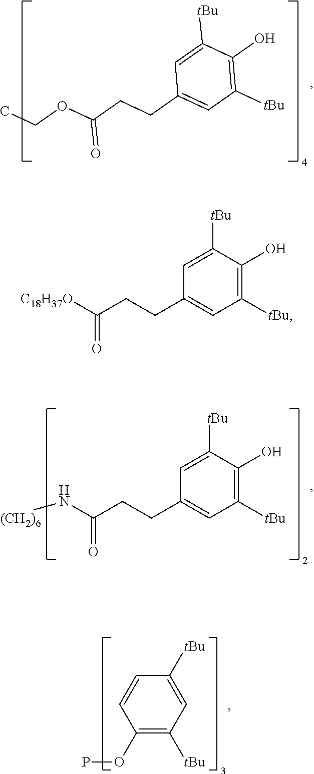

and
a 1:1 mixture of

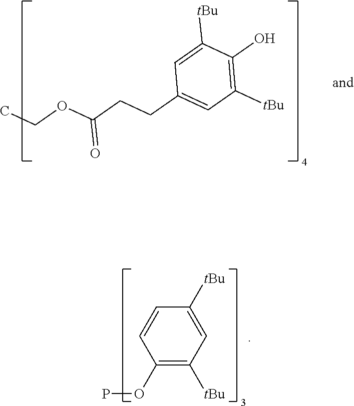

The antimicrobial polymer composite described herein can be prepared by blending or mixing the essential ingredients, and other optional components, as uniformly as possible employing any conventional blending means. Mixing can be performed in any way known to the person skilled in the art. Commonly used mixing devices are a tumbler mixer, a high-speed mixer; blenders, for example V blender, ribbon blender or a cone blender; mixers, for example a jet mixer, a planetary mixer or a Banbury mixer. During mixing the mixture can be preheated. Mixing can also be performed in a part of an extruder

The antimicrobial polymer composite can be molded into a shape such as a pellet, but also semi-finished product or an article. Suitable examples of processes in which the antimicrobial polymer composite is formed into a shape include blow molding, injection molding, compression molding, thermoforming, film blowing, casting and extrusion compression molding. Film blowing is widely used to produce films. Injection molding and blow molding are widely used to produce articles such as, bottles, boxes and containers. Extrusion is widely used to produce articles for example rods, sheets and pipes.

The antimicrobial polymer composite described herein can be used in the preparation of plastic articles with microbe-repellant and/or biocidal functions. The present disclosure also contemplates the use of the antimicrobial polymer composite for the preparation of an article. The article can be an article for the storage or transport of food or beverages.

In certain embodiments, the article is a pipe for the transport of a fluid. The fluid can be a beverage, for example water and for example a soft drink, wine, beer or milk.

In certain embodiments, the article is a flexible packaging. Suitable examples are films, sheets, plastic bags, containers, bottles, boxes and buckets. In certain embodiments, the antimicrobial polymer composite is used for pharmaceutical packaging, such as for example in primary packaging that is in direct contact with the active pharmaceutical ingredient and includes blister packs, fluid bags, pouches, bottles, vials and ampoules.

In certain embodiments, the article is used in medical applications. Medical applications include for example closures, rigid bottles and ampoules, needle sheaths, plunger rods for single-use syringes, moldings to house diagnostic equipment, collapsible tube shoulders, blow-fill-seal products, collapsible tube bodies, film for primary and secondary medical and pharmaceutical packaging, disposable syringes, actuator bodies, specimen cups, mouldings to house diagnostic equipment, centrifuge tubes, multi-well micro-titration plates, trays, pipettes and caps and closures.

The present disclosure also provides an antimicrobial coating formulation comprising: an antimicrobial agent, an antifouling agent, and a monomer, wherein the antifouling agent has bacteria-repellent properties. The antimicrobial coating formulation can be used to impart durable antimicrobial properties to a surface or substrate.

The antimicrobial coating formulation can comprise an antimicrobial agent and an antifouling agent as defined herein.

The monomer can be an alkyl acrylate, an alkyl methacrylate, acrylic acid, methacrylic acid, an epoxy resin, or a mixture thereof.

In certain embodiments, the epoxy resin is a novolac epoxy resin, poly(glycidyl methacrylate), and poly(glycidyl acrylate), a terpolymer of ethylene, methyl methacrylate and glycidyl methacrylate, a terpolymer of ethylene, acrylic ester, glycidyl methacrylate, epoxy functionalized polybutadiene, or epoxy functionalized poly(butadiene-co-polystyrene); or the epoxy resin is selected from the group consisting of:

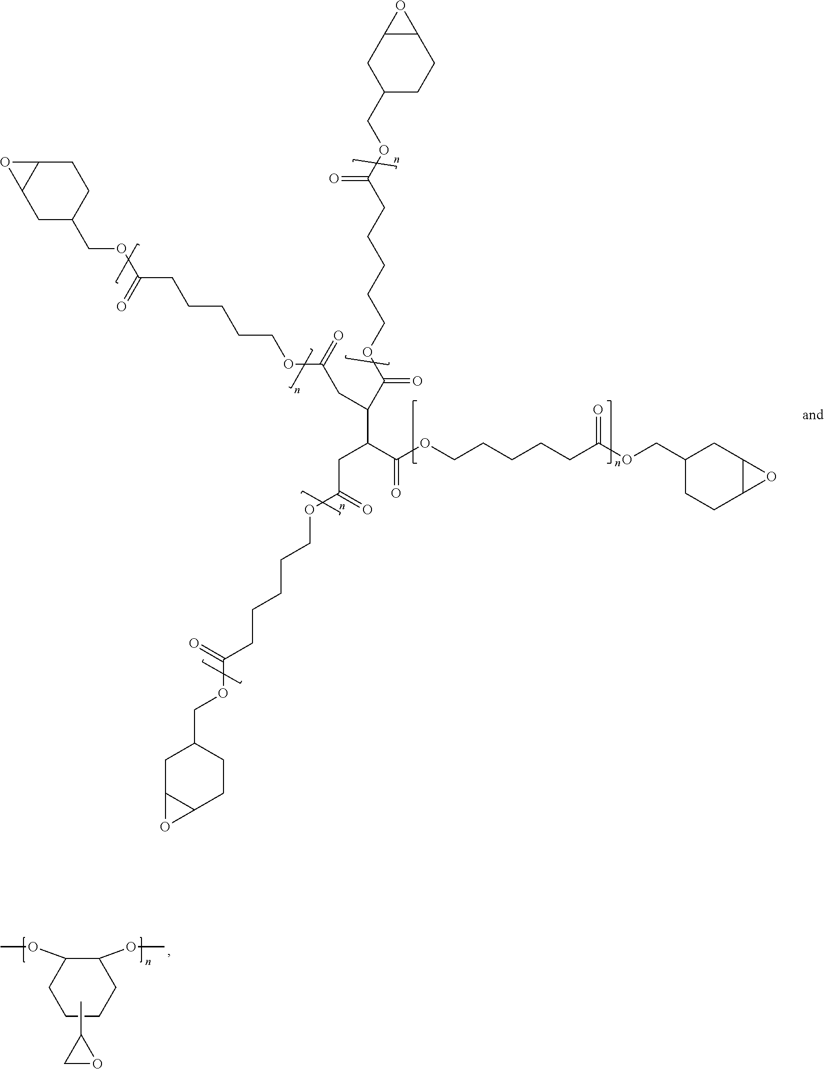

wherein n for each instance is independently 1-10,000.

In certain embodiments, the epoxy resin is a novolac epoxy resin, poly(glycidyl methacrylate), a terpolymer of ethylene, acrylic ester, glycidyl methacrylate, epoxy functionalized polybutadiene, or epoxy functionalized poly(butadiene-co-poly styrene).

In certain embodiments, the bacteria repellent agent is a polyethylene glycol ether of cetearyl alcohol, poly(ethylene glycol) sorbitol hexaoleate, cocamidopropyl betaine, N-(1-oxododecyl)-glutamate, sodium lauroyl sarcosinate or a mixture thereof; and the epoxy resin is a novolac epoxy resin, poly(glycidyl methacrylate), a terpolymer of ethylene, acrylic ester, glycidyl methacrylate, epoxy functionalized polybutadiene, or an epoxy functionalized poly(butadiene-co-polystyrene).

The antimicrobial agent can be present in the antimicrobial coating formulation at a concentration between about 0.1 to about 10 parts per hundred, about 0.1 to about 9 parts per hundred, about 0.1 to about 8 parts per hundred, about 0.1 to about 7 parts per hundred, about 0.1 to about 6 parts per hundred, about 0.1 to about 5 parts per hundred, about 0.1 to about 4.5 parts per hundred, about 0.1 to about 4 parts per hundred, about 0.1 to about 3.5 parts per hundred, about 0.1 to about 3 parts per hundred, about 0.5 to about 5 parts per hundred, about 1 to about 5 parts per hundred, about 1.5 to about 5 parts per hundred, about 2 to about 5 parts per hundred, about 2.5 to about 5 parts per hundred, about 3 to about 5 parts per hundred, about 3.5 to about 5 parts per hundred, about 4 to about 5 parts per hundred, about 4.5 to about 5 parts per hundred, about 1 to about 4.5 parts per hundred, about 1.5 to about 4.5 parts per hundred, about 2 to about 4 parts per hundred, or about 2.5 to about 3.5 parts per hundred relative to the monomer.

The antifouling agent can be present in the antimicrobial coating formulation at a concentration between about 0.1 to about 10 parts per hundred, about 0.1 to about 9 parts per hundred, about 0.1 to about 8 parts per hundred, about 0.1 to about 7 parts per hundred, about 0.1 to about 6 parts per hundred, about 0.1 to about 5 parts per hundred, about 0.1 to about 4.5 parts per hundred, about 0.1 to about 4 parts per hundred, about 0.1 to about 3.5 parts per hundred, about 0.1 to about 3 parts per hundred, about 0.5 to about 5 parts per hundred, about 1 to about 5 parts per hundred, about 1.5 to about 5 parts per hundred, about 2 to about 5 parts per hundred, about 2.5 to about 5 parts per hundred, about 3 to about 5 parts per hundred, about 3.5 to about 5 parts per hundred, about 4 to about 5 parts per hundred, about 4.5 to about 5 parts per hundred, about 1 to about 4.5 parts per hundred, about 1.5 to about 4.5 parts per hundred, about 2 to about 4 parts per hundred, or about 2.5 to about 3.5 parts per hundred relative to the monomer. The antimicrobial coating formulation can be applied to a substrate by depositing the antimicrobial coating formulation on a surface of the substrate thereby forming a coated substrate and optionally curing the coated substrate.

The antimicrobial coating formulation can be deposited using any suitable conventional method known in the art including, but not limited to, spin coating, printing, print screening, spraying, painting, and dip coating.

The step of curing can comprise at least one method from the group consisting of heating the coated substrate at a temperature between about 30 to about 200° C., about 30 to about 150° C., about 30 to about 100° C., or about 350 to about 150° C.; and irradiating the coated substrate with ultraviolet radiation.

Also provided is a sprayable antimicrobial coating formulation comprising: an antimicrobial agent, an antifouling agent, a film forming agent, and a solvent wherein the antifouling agent has bacteria-repellent properties.

In certain embodiments, the antifouling agent is non-biocidal. Antifouling agents useful in the sprayable antimicrobial coating formulation include, but are not limited to, the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, an alkoxy polyethyleneglycol, an alkoxy polyethyleneglycol alkyltrialkoxysilane, a polyglycerol, a poloxamer, an ethoxylated cetearyl alcohol, a polyethylene glycol diester of stearic acid and combinations thereof.

Exemplary antifouling agents useful in the sprayable antimicrobial coating formulation include, but are not limited to, 3-[methoxy(polyethyleneoxy)9-12]propyltrimethoxysilane, poly(ethylene glycol) methyl ether, and mixtures thereof.

The antimicrobial agent used in the sprayable antimicrobial coating formulation can be a quaternary ammonium compound, a quaternary phosphonium compound, a poly-quaternary ammonium compound, a poly-quaternary phosphonium compound, a polyalkyl guanidinium salt, a polyalkyl guanidine, a polyethyleneimine, or a combination thereof.

In certain embodiments, the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

In certain embodiments, the antimicrobial agent has the Formula 1:

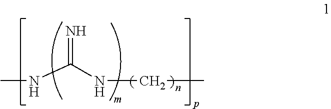

or a conjugate salt thereof, wherein
m is 1, 2, or 3;
n is a whole number selected from 2-12; and
p is a whole number selected from 2-12.

In certain embodiments, the antimicrobial agent is a polyhexamethylene guanidine (PHMG), a polyhexamethylene biguanidine (PHMB), dimethyloctadecyl[3-(trimethoxysilyl)propyl]ammonium halide, a diallyl dimethyl ammonium halide, a branched polyethylenimine, or a mixture thereof.

Exemplary antimicrobial agents useful in the sprayable antimicrobial coating formulation include, but are not limited to, dimethyloctadecyl[3-(trihydroxysilyl)propyl]ammonium chloride, diallyl dimethyl ammonium chloride, polyhexamethylene biguanide, and mixtures thereof.

The film forming agent can be any polymer that is at least partially soluble in the solvent. In certain embodiments, the film forming agent is selected from the group consisting of polyvinyl alcohol, polyvinyl pyrrolidone, polyacrylic acid, polyacrylamide, polymethacrylamide, polyethylene oxide, polyalkyl vinyl ether, polyurethane, carboxymethylcellulose, methylcellulose, hydroxypropylcellulose, chitosan, sodium alginate, and mixtures and/or copolymers thereof. In certain embodiments, the film forming agent is polyvinyl pyrrolidone.

Solvent useful in the sprayable antimicrobial coating formulation include water, alcohol, and mixtures thereof. Exemplary alcohols include, but are not limited to, ethanol, isopropanol, n-propanol, 1,2-propanediol, and 1,2-butanediol. In certain embodiments, the solvent has a boiling point lower than about 150° C., lower than about 125° C., lower than about 100° C., or lower than about 75° C.

The sprayable antimicrobial coating formulation can optionally further comprise one or more additional additives selected from the group consisting of colorants, rheology modifiers, plasticizers, surfactants, solubilizers, antioxidants, pH adjusters, wetting agents, anti-foaming agents, bulking agents, lubricants, processing aids, anti-discoloring agents, and antioxidants.

The antimicrobial agent can be present in the sprayable antimicrobial coating formulation at a concentration between about 0.1 to about 5 parts per hundred; about 0.1 to about 4.5 parts per hundred; about 0.1 to about 4 parts per hundred; about 0.1 to about 3.5 parts per hundred; about 0.1 to about 3 parts per hundred; about 0.1 to about 2.5 parts per hundred; about 0.1 to about 2 parts per hundred; about 0.1 to about 1.5 parts per hundred; about 0.1 to about 1 part per hundred; about 0.5 to about 1 part per hundred; about 0.6 to about 1 part per hundred; about 0.7 to about 1 part per hundred; about 0.8 to about 1 part per hundred; about 0.8 to about 3 part per hundred; about 1 to about 3 parts per hundred; about 1.5 to about 3 parts per hundred; or about 2 to about 3 parts per hundred.

The antifouling agent can be present in the sprayable antimicrobial coating formulation at a concentration between about 0.1 to about 5 parts per hundred; about 0.1 to about 4.5 parts per hundred; about 0.1 to about 4 parts per hundred; about 0.1 to about 3.5 parts per hundred; about 0.1 to about 3 parts per hundred; about 0.1 to about 2.5 parts per hundred; about 0.5 to about 2.5 parts per hundred; about 0.5 to about 2 parts per hundred; about 0.5 to about 1.5 parts per hundred; about 0.5 to about 1 parts per hundred; about 1 to about 2 parts per hundred; about 1 to about 1.5 parts per hundred; or about 1.5 to about 2 parts per hundred.

The film forming agent can be present in the sprayable antimicrobial coating formulation at a concentration between about 0.1 and 5 parts per hundred; about 0.1 and 4.5 parts per hundred; about 0.1 and 4 parts per hundred; about 0.1 and 3.5 parts per hundred; about 0.1 and 3 parts per hundred; about 0.1 and 2.5 parts per hundred; about 0.5 and 2.5 parts per hundred; about 0.5 and 2 parts per hundred; about 0.5 and 1.5 parts per hundred; about 0.5 and 1 part per hundred; about 1 and 1.5 parts per hundred; or about 1 and 2 parts per hundred.

The present disclosure also provides a method of applying sprayable antimicrobial coating formulation to a substrate, the method comprising: depositing the sprayable antimicrobial coating formulation on a surface of the substrate thereby forming a coated substrate and optionally drying the coated substrate.

The method of depositing the sprayable antimicrobial coating formulation on the substrate is not particularly limited. The sprayable antimicrobial coating formulation can be deposited using any suitable conventional method known in the art including, but not limited to, spin coating, printing, print screening, spraying, painting, and dip coating.

The sprayable antimicrobial coating formulation described herein can be applied to a variety of substrates, including glass, polymers, plastics, ceramic, silicon, metals, wood, paper, stone, and cellulose. Exemplary polymers include synthetic and naturally occurring organic and inorganic polymers, such as polyethylene, polypropylene, polyacrylates, polycarbonate, polyamides, polyurethane, polyvinylchloride, polyetherketone, polytetrafluroethylene, cellulose, silicone, and rubber.

The coated substrate can be optionally dried using any method known in the art including, but not limited to, air-drying, infrared radiation, convection drying, or warm forced air.

### EXAMPLES

### Example 1—Polypropylene Homopolymer Antimicrobial Composite

The polypropylene homopolymer (PPH) antimicrobial composite was prepared by combining the reagents specified in the following tables in the proportions indicated.

| | | Specified | | |
|---|---|---|---|---|
| Function | Material | Additives | GP-4 | AGP-4 |
| Base resin | Polyolefin | Polypropylene | Base Resin | |
| | | homopolymer | | |
| Antimicrobial | Quaternary | Methyltrioctyl- | 2.5 phr | |
| agent | ammonium | ammonium | | |
| | chloride | bromide | | |
| | | (CAS NO. | | |
| | | 35675-80-0) | | |
| Antifouling | Polyoxypropylene- | BASF Pluronic | N.A. | 2 phr |

| | | | |
|---|---|---|---|
| additive | polyoxyethylene | F127 | |
| | Block Copolymer | (CAS NO. | |
| | | 9003-11-6) | |
| Processing | Maleic anhydride | DOW | 2 phr |
| additive | grafted polymer | AMPLIFY | |
| | | GR216 | |
| | Phenolic primary | Irganox 1010 | 0.5 phr |
| | antioxidant | (CAS NO. | |
| | | 6683-19-8) | |

The antimicrobial properties of the thus prepared polymer composites are shown in the table below.

| | Antibacterial | Antibacterial |
|---|---|---|
| | Efficacy | Efficacy |
| Formulation | (S. aureus) | (E. coli) |
| GP-4 | 24.30% | 99.90% |
| AGP-4 | >99.9% | >99.9% |

### Example 2—Polypropylene Homopolymer Antimicrobial Composite

The polypropylene homopolymer (PPH) antimicrobial composite was prepared by combining the reagents specified in the following tables in the proportions indicated.

| Function | Material | Specified Additives | Ratio |
|---|---|---|---|
| Base resin | Polyolefin | Polypropylene | Base |
| | | homopolymer | Resin |
| Antimicrobial | Polyguanidine | Polyhexamethylene | 1.25 phr* |
| agent | | Biguanide | |
| | | (CAS NO. 32289-58-0) | |
| Antifouling | Polyoxypropylene- | Polaxamer 407 | 1.2 phr |
| additive | polyoxyethylene | anti-biofouling | |
| | Block | compound | |
| | Copolymer | (CAS NO. 9003-11-6) | |
| Processing | Random copolymer of | Lotader AX8840 | 1.25 phr |
| additive | ethylene and glycidyl | | |
| | methacrylate | | |
| | Phenolic primary | Irganox 1010 | 0.25 phr |
| | antioxidant | (CAS NO. 6683-19-8) | |

The antimicrobial properties of the thus prepared polymer composites are shown in the table below.

| | Antibacterial | Antibacterial |
|---|---|---|
| | Efficacy | Efficacy |
| Formulation | (S. aureus) | (E. coli) |
| AGP-18-2 | >99.9% | >99.9% |

### Example 3—Polypropylene Homopolymer Antimicrobial Composite

The polypropylene homopolymer (PPH) antimicrobial composite was prepared by combining the reagents specified in the following tables in the proportions indicated.

| | | | | | | |
|---|---|---|---|---|---|---|
| | | Specified | | | | |
| Function | Material | Additives | GP-39 | AGP-69 | AGP-70 | AP-73 |

| Base resin | Polyolefin | Polypropylene | Base Resin | |
|---|---|---|---|---|
| | | homopolymer | | |
| Antimicrobial | Polyguanidine | Polyhexamethylene | 0.42 phr | N.A. |
| agent | | guanidine | | |
| | | hydrochloride | | |
| | | (CAS NO. 57028-96-3) | | |

| | | | | | |
|---|---|---|---|---|---|
| Antifouling | Polyglycerol ester/ | GRINDSTED PS 432 | N.A. | 1.2 phr | 2.5 phr |
| additive | acetic acid ester blend | (CAS NO. 736150-63-3, | | | |
| | | 33940-98-6) | | | |

The antimicrobial properties of the thus prepared polymer composites are shown in the table below.

| | Antibacterial | Antibacterial |
|---|---|---|
| | Efficacy | Efficacy |
| Sample | (S. aureus) | (E. coli) |
| GP-39 | 90.93% | >99.9% |
| AGP-69 | >99.9% | —* |
| AGP-70 | >99.9% | — |
| AP-73 | No effect | No effect |

*Not tested.

### Example 4—Polypropylene Homopolymer Antimicrobial Composite

The polypropylene homopolymer (PPH) antimicrobial composite was prepared by combining the reagents specified in the following tables in the proportions indicated.

| Function | Material | Specified Additives | AGP-59 | AGP-60 | GP-59 |
|---|---|---|---|---|---|
| Base resin | Polyolefin | Polypropylene | Base Resin | | |
| | | homopolymer | | | |
| Antimicrobial | Polyguanidine | Polyhexamethylene | 1.25 phr | | |
| agent | | guanidine | | | |
| | | hydrochloride | | | |
| | | (CAS NO. 57028-96-3) | | | |
| | Quaternary | Dimethyloctadecyl[3- | 0.5 phr | | |
| | ammonium | (trihydroxysilyl)propyl] | | | |
| | chloride | ammonium chloride | | | |
| | | (CAS No. 199111-50-7) | | | |
| Antifouling | Polyglycerol | GRINDSTED PS 432 | 2.5 phr | 1.2 phr | N.A. |

| | | | |
|---|---|---|---|
| additive | ester/acetic acid | (CAS NO. 736150-63-3, | |
| | ester blend | 33940-98-6) | |
| | | (CAS NO. 9005-08-7) | |
| Processing | Random copolymer | Lotader AX8840 | 2.5 phr |
| additive | of ethylene and | | |
| | glycidyl methacrylate | | |
| | Phenolic primary | Irganox 1010 | 0.5 phr |
| | antioxidant | (CAS NO. 6683-19-8) | |

The antimicrobial properties of the thus prepared polymer composites are shown in the table below.

| | Antibacterial Efficacy (S. aureus) | | | Antibacterial Efficacy (E. coli) | | |
|---|---|---|---|---|---|---|
| Sample | 1^{st} Challenge | 2^{nd} Challenge | 3^{rd} Challenge | 1^{st} Challenge | 2^{nd} Challenge | 3^{rd} Challenge |
| AGP-59 | >99.9% | 97.30% | 92.10% | >99.9% | 99.97% | >99.9% |
| AGP-60 | >99.9% | 91.50% | 68.82% | >99.9% | 99.92% | >99.99% |
| GP-59 | 93.91% | 48.25% | 67.11% | — | — | — |

### Example 5—Tritan Antimicrobial Composite

The Tritan antimicrobial composite was prepared by combining the reagents specified in the following tables in the proportions indicated.

| Function | Material | Specified Additives | Ratio |
|---|---|---|---|
| Base resin | Copolyester | Tritan TX1001 | Base |
| | | | Resin |
| Antimicrobial | Polyguanidine | Polyhexamethylene | 2 phr |
| agent | | guanidine hydrochloride | |
| | | (CAS NO. 57028-96-3) | |
| | Quaternary | Dimethyloctadecyl[3- | 0.5 phr |
| | ammonium | (trihydroxysilyl)propyl] | |
| | chloride | ammonium chloride | |
| | | (CAS NO. 199111-50-7) | |
| Antifouling | Sorbitol based | Atlas ™ G1096 | 1 phr |
| additive | surfactant | (CAS NO. 57171-56-9) | |
| | Ethoxylated | Eumulgin B2 | 1 phr |
| | cetearyl | (CAS NO. 68439-49-6) | |
| | alcohol | | |
| Processing | Slip additive | Incromax 100 | 0.5 phr |
| additive | | (Proprietary) | |
| | Phenolic | Irganox 1076 | 0.25 phr |
| | primary | (CAS NO. 2082-79-3) | |
| | antioxidant | | |
| | Hydrolytically | Irgafos 168 | 0.25 phr |
| | stable | (CAS NO. 31570-04-4) | |
| | phosphite | | |
| | processing | | |
| | stabilizer | | |

The antimicrobial properties of the thus prepared polymer composites are shown in the table below.

| | Antibacterial | Antibacterial |
|---|---|---|
| | Efficacy | Efficacy |
| Formulation | (S. aureus) | (E. coli) |
| AGT-21 | >99.9% | >99.9% |

### Example 6—Tritan Antimicrobial Composite

The Tritan antimicrobial composite was prepared by combining the reagents specified in the following tables in the proportions indicated.

| | | | GT- | AGT- |
|---|---|---|---|---|
| Function | Material | Specified Additives | 12 | 14 |
| Base resin | Copolyester | Tritan TX1001 | Base Resin | |
| Antimicrobial | Polyguanidine | Polyhexamethylene | 1.25 phr | |
| agent | | guanidine | | |
| | | hydrochloride | | |
| | | (CAS NO. 57028-96-3) | | |
| Antifouling | Sorbitol based | Atlas ™ G1096 | N.A. | 0.6 phr |
| additive | surfactant | (CAS NO. 57171-56-9) | | |
| | Ethoxylated | Eumulgin B2 | N.A. | 0.6 phr |

| | | | |
|---|---|---|---|
| | cetearyl | (CAS NO. 68439-49-6) | |
| | alcohol | | |
| Processing | Slip additive | Incromax ™ 100 | 0.5 phr |
| additive | Phenolic | Irganox ® 1076 | 0.125 phr |
| | primary | (CAS NO. 2082-79-3) | |
| | antioxidant | | |
| | Hydrolytically | Irgafos ® 168 | 0.125 phr |
| | stable | (CAS NO. 31570-04-4) | |
| | phosphite | | |
| | processing | | |
| | stabilizer | | |

The antimicrobial properties of the thus prepared polymer composites are shown in the table below.

| | Antibacterial | Antibacterial |
|---|---|---|
| | Efficacy | Efficacy |
| Formulation | (S. aureus) | (E. coli) |
| AGT-14 | >99.9% | >99.9% |
| GT-12 | 80.1% | 76.8% |

### Example 7—Epoxy-Based Antimicrobial Coating

The epoxy-based antimicrobial coating was prepared by combining the reagents specified in the following tables in the proportions indicated. The antimicrobial properties of the antimicrobial coating are shown in the tables below.

| | | Antimicrobial agent/part | | | | | |
|---|---|---|---|---|---|---|---|
| | | Quaternary | Antifouling | | | | |
| | | Ammonium Chloride | Additive/part | | | | |
| | | Dimethyloctadecy[3- | Polyether | | | | |
| | | (trimethoxysilyl)propyl] | Poly(ethylene | | | | |
| | | ammonium chloride | glycol) methyl | Antibacterial | | Antibacterial | |
| | | solution (60 wt. % in | ether, Mn | Efficacy | | Efficacy | |
| | | methanol) | ~550 (CAS NO. | (S. aureus) | | (E. coli) | |
| Sample | Base | (CAS NO. 27668-52-6) | 9004-74-4) | 2 hrs | 24 hrs | 2 hrs | 24 hrs |
| EC4 | Epoxy- | 3 | 0 | 96.80% | >99.9% | — | >99.9% |
| EC6 | based | 3 | 5 | 100.00% | >99.9% | — | >99.9% |
| EC8 | coating | 5 | 0 | 99.90% | — | — | — |
| EC10 | | 5 | 8 | >99.9% | — | >99.9% | — |

| | | Antifouling | | | |
|---|---|---|---|---|---|
| | Antimicrobial agent/phr | Additive/phr | | | |
| | Quaternary Ammonium | Polyether | | | |
| | Chloride | Poly(ethylene | | | |
| | Dimethyloctadecy[3- | glycol) | | | |
| | (trimethoxysilyl)propyl] | methyl ether, | Antibacterial Efficacy | | |
| | ammonium chloride solution | Mn ~550 | (S. aureus) | | |
| | (60 wt. % in methanol) | (CAS NO. | 1^{st} | 2^{nd} | 3^{rd} |
| Base | (CAS NO. 27668-52-6) | 9004-74-4) | Challenge | Challenge | Challenge |
| Epoxy-based | 3 | 0 | 51.50% | 14.50% | 27.70% |
| coating | 3 | 5 | >99.9% | 97.20% | 98.70% |
| | 3 | 8 | >99.9% | >99.9% | >99.9% |
| | 5 | 0 | 32.40% | 27.00% | −10.00% |
| | 5 | 8 | >99.9% | >99.9% | 99.70% |

### Example 8—Water-Based Sprayable Antimicrobial Coating Formulation

The water-based sprayable antimicrobial coating (AGD-58) was prepared by combining water with the reagents specified in the following tables in the proportions indicated. The antimicrobial properties of the antimicrobial spray are shown in the tables below.

| Function | Material | Specified Additives | Ratio |
|---|---|---|---|
| Antimicrobial | Polyhexanide | Polyhexamethylene | 0.8 phr |
| agent | | biguanide hydrochloride | |
| | | (CAS NO. 27083-27-8) | |
| | Ethyleneimine | Polyethylenimine, branched | 2 phr |
| | polymer | (CAS NO. 9002-98-6) | |
| Antifouling | Polyether | Poly(ethylene glycol) | 2 phr |
| additive | | methyl ether, Mn ~550 | |
| | | (CAS NO. 9004-74-4) | |
| Anchoring | Water soluble | Polyvinylpyrrolidone K30 | 2 phr |
| agent | polymer | (CAS Number: 9003-39-8) | |

| | Antibacterial | Antibacterial |
|---|---|---|
| | Efficacy | Efficacy |
| Formulation | (S. aureus) | (E. coli) |
| AGD-58 | >99.9% | >99.9% |

### Example 9—Water-Based Sprayable Antimicrobial Coating Formulation

The water-based sprayable antimicrobial formulation was prepared by combining water with the reagents specified in the following tables in the proportions indicated. The antimicrobial properties of the water-based sprayable antimicrobial coating formulation are shown in the tables below.

| | | | | Antibacterial Efficacy | |
|---|---|---|---|---|---|
| | | | | of sprayed glasses | |
| | | | | (S. aureus) | |
| | Antimicrobial | Antifouling | Anchoring | 1^{st} | 2^{nd} |
| Formulation | agent/phr | additive/phr | agent/phr | challenge | challenge |
| GS-21 | Dimethyloctadecyl | N.A. | Polyvinylpyrrolidone | <50% | <50% |
| | [3-(trihydroxysilyl) | | K30 (CAS Number: | | |
| | propyl]ammonium | | 9003-39-8)/0.5 phr | | |
| | chloride (DTSACl) | | | | |
| | (CAS NO. | | | | |
| AGS-21 | 199111-50-7)/0.8 phr | 3-[Methoxy | | >99.9% | >99.9% |
| | Diallyl dimethyl | (Polyethyleneoxy)9-12] | | | |
| | ammonium chloride | Propyltrimethoxysilane | | | |
| | (DDAC) | (CAS: 65994-07-2)/1 phr | | | |
| | (CAS: 7398-69-8)/ | | | | |
| | 0.18 phr | | | | |

The antimicrobial properties of the additional water-based sprayable antimicrobial coating formulations are shown in FIG. 9.

What is claimed:

1. An antimicrobial polymer composite comprising: an antimicrobial agent, an antifouling agent, and a base polymer, wherein the antifouling agent has bacteria-repellent properties.

2. The antimicrobial polymer composite of claim 1, wherein the antifouling agent is non-biocidal.

3. The antimicrobial polymer composite of claim 1, wherein the antifouling agent is a polyether.

4. The antimicrobial polymer composite of claim 3, wherein the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, a polyglycerol, a poloxamer, an ethoxylated cetearyl alcohol, a polyethylene glycol diester of stearic acid and combinations thereof.

5. The antimicrobial polymer composite of claim 1, wherein the antimicrobial agent is a quaternary ammonium compound, a quaternary phosphonium compound, a poly-quaternary ammonium compound, a poly-quaternary phosphonium compound, a polyalkyl guanidinium salt, a polyalkyl guanidine, or a combination thereof.

6. The antimicrobial polymer composite of claim 5, wherein the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

7. The antimicrobial polymer composite of claim 1, wherein the antimicrobial agent is R₄Y⁺X⁻, wherein Y is phosphorus or nitrogen; R for each instance is independently selected from the group consisting of alkyl and aryl; and X is an anion.

8. The antimicrobial polymer composite of claim 1, wherein the antimicrobial agent has the Formula 1: 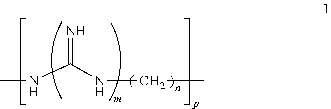
or a conjugate salt thereof, wherein
m is 1, 2, or 3;
n is a whole number selected from 2-12; and
p is a whole number selected from 2-12.

9. The antimicrobial polymer composite of claim 1, wherein the antimicrobial agent is a polyhexamethylene guanidine (PHMG), a polyhexamethylene biguanidine (PHMB), a C₄-C₁₄ alkyl(triphenyl)phosphonium halide, a C₄-C₁₄ tetraalkylphosphonium halide, a dimethyloctadecyl[3-(trimethoxysilyl)propyl]ammonium halide, a diallyl dimethyl ammonium halide, or a mixture thereof.

10. The antimicrobial polymer composite of claim 1, wherein the base polymer is selected from the group consisting of a polyvinyl chloride, polyolefin, polyether, polyvinyl, polyester, polyacetal, polyamide, polyurethane, polyacrylate, polycarbonate, polyimide, polyphthalate, polysulfone, polythioether, polyketone, acrylonitrile butadiene styrene, ethylene vinyl acetate, and mixtures thereof.

11. The antimicrobial polymer composite of claim 1, wherein the base polymer is a polyolefin, a polyester, a polyvinyl chloride, or mixture thereof.

12. The antimicrobial polymer composite of claim 1, wherein the antifouling agent is a polyethylene glycol sorbitan monolaurate, a polyethylene glycol sorbitan monooleate, a poly(ethylene glycol) sorbitol hexaoleate, a polyethene-block-poly(ethylene glycol), a polyethyleneglycol, an alkyl polyethyleneglycol, a polyglycerol, an ethoxylated cetearyl alcohol, or a combination thereof; the antimicrobial agent is a quaternary ammonium compound, a quaternary phosphonium compound, a polyalkyl guanidinium salt, a polyalkyl guanidine, or a combination thereof; and the base polymer is selected from the group consisting of a polyvinyl chloride, polyolefin, polyether, polyester, polyacetal, polyamide, polyurethane, polyacrylate, polycarbonate, polyimide, polyphthalate, polysulfone, polythioether, polyketone, acrylonitrile butadiene styrene, ethylene vinyl acetate, and mixtures thereof.

13. The antimicrobial polymer composite of claim 1, wherein the antifouling agent is a polyoxypropylenepolyoxyethylene, polyethyleneglycol, or a mixture thereof; the antimicrobial agent is a polyhexamethylene guanidine (PHMG), a polyhexamethylene biguanidine (PHMB), a C₄-C₁₄ alkyl(triphenyl)phosphonium halide, a C₄-C₁₄ tetraalkylphosphonium halide, or a mixture thereof; and the base polymer is a polyvinyl chloride, polyolefin, or a polyester.

14. The antimicrobial polymer composite of claim 1, wherein the antimicrobial agent and the antifouling agent are each independently present in the antimicrobial polymer composite at a concentration between about 0.1 to about 5 parts per hundred relative to the base polymer.

15. The antimicrobial polymer composite of claim 13, wherein the antimicrobial agent and the antifouling agent are each independently present in the antimicrobial polymer composite at a concentration between about 0.5 to about 3 parts per hundred relative to the base polymer.

16. The antimicrobial polymer composite of claim 1 further comprising an additive selected from the group consisting of antioxidants, brighteners, nucleating agents, mold release agents, color stabilizers, UV stabilizers, fillers, plasticizers, impact modifiers, colorants, lubricants, antistatic agents, fire retardants, processing additive, and anti-ester exchange agents.

17. The antimicrobial polymer composite of claim 1 further comprising an additive selected from the group consisting of BASF Pluronic® F127, DOW AMPLIFY™ GR216, Irganox® 1010, Lotader® AX8840, Incromax® 100, Irganox® 1076, and Irgafos® 168.

18. An antimicrobial coating formulation comprising: an antimicrobial agent, an antifouling agent, and a monomer, wherein the antifouling agent has bacteria-repellent properties.

19. The antimicrobial coating formulation of claim 18, wherein the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, a polyglycerol, a poloxamer, an ethoxylated cetearyl alcohol, a polyethylene glycol diester of stearic acid and combinations thereof.

20. The antimicrobial coating formulation of claim 18, wherein the antimicrobial agent is a quaternary ammonium compound, a quaternary phosphonium compound, a poly-quaternary ammonium compound, a poly-quaternary phosphonium compound, a polyalkyl guanidinium salt, a polyalkyl guanidine, or a combination thereof.

21. The antimicrobial coating formulation of claim 20, wherein the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

22. The antimicrobial coating formulation of claim 18, wherein the antimicrobial agent is R₄P⁺X⁻, wherein R for each instance is independently selected from the group consisting of alkyl and aryl; and X is an anion.

23. The antimicrobial coating formulation of claim 18, wherein the antimicrobial agent has the Formula 1: 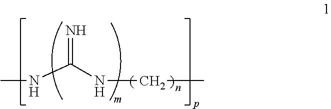
or a conjugate salt thereof, wherein
m is 1, 2, or 3;
n is a whole number selected from 2-12; and
p is a whole number selected from 2-12.

24. The antimicrobial coating formulation of claim 18, wherein the antimicrobial agent is a polyhexamethylene guanidine (PHMG), a polyhexamethylene biguanidine (PHMB), a a C₄-C₁₄ alkyl(triphenyl)phosphonium halide, a C₄-C₁₄ tetraalkylphosphonium halide, a dimethyloctadecyl[3-(trimethoxysilyl)propyl]ammonium halide, a diallyl dimethyl ammonium halide, or a mixture thereof.

25. The antimicrobial coating formulation of claim 18, wherein the monomer is selected from the group consisting of an alkyl acrylate, an alkyl methacrylate, acrylic acid, methacrylic acid, an epoxy resin, and a mixture thereof.

26. The antimicrobial coating formulation of claim 18, wherein the monomer is methacrylic acid, an epoxy resin, or a mixture thereof.

27. The antimicrobial coating formulation of claim 18, wherein the antifouling agent is a polyethylene glycol sorbitan monolaurate, a polyethylene glycol sorbitan monooleate, a poly(ethylene glycol) sorbitol hexaoleate, a polyethene-block-poly(ethylene glycol), a polyethyleneglycol, an alkyl polyethyleneglycol, a polyglycerol, an ethoxylated cetearyl alcohol, or a combination thereof; the antimicrobial agent is a quaternary ammonium compound, a quaternary phosphonium compound, a polyalkyl guanidinium salt, a polyalkyl guanidine, or a combination thereof; and the monomer is selected from the group consisting of an alkyl acrylate, an alkyl methacrylate, acrylic acid, methacrylic acid, an epoxy resin, and a mixture thereof.

28. The antimicrobial coating formulation of claim 18, wherein the antifouling agent is a polyethyleneglycol; the antimicrobial agent is a dimethyloctadecyl[3-(trimethoxysilyl)propyl]ammonium halide, a diallyl dimethyl ammonium halide or a mixture thereof; and the monomer is acrylic acid, methacrylic acid, an epoxy resin, or a mixture thereof.

29. The antimicrobial coating formulation of claim 18, wherein the antimicrobial agent and the antifouling agent are each independently present in the antimicrobial polymer composite at a concentration between about 1 to about 10 parts per hundred relative to the base polymer.

30. The antimicrobial coating formulation of claim 28, wherein the antimicrobial agent and the antifouling agent are each independently present in the antimicrobial polymer composite at a concentration between about 2 to about 10 parts per hundred relative to the base polymer.

31. A method of applying the antimicrobial coating formulation of claim 16 to a substrate, the method comprising: depositing the antimicrobial coating formulation on a surface of the substrate thereby forming a coated substrate and optionally curing the coated substrate.

32. The method of claim 31, wherein the step of curing comprises at least one method selected from the group consisting of heating the coated substrate at a temperature between 30-200° C. and irradiating the coated substrate with ultraviolet radiation.

33. A sprayable antimicrobial coating formulation comprising: an antimicrobial agent, an antifouling agent, a film forming agent, and a solvent, wherein the antifouling agent has bacteria-repellent properties.

34. The sprayable antimicrobial coating formulation of claim 33, wherein the antifouling agent is selected from the group consisting of polyethylene glycol sorbitan monolaurate, polyethylene glycol sorbitan monooleate, poly(ethylene glycol) sorbitol hexaoleate, polyethene-block-poly(ethylene glycol), a polyethyleneglycol, an alkyl polyethyleneglycol, an alkoxy polyethyleneglycol, an alkoxy polyethyleneglycol alkyltrialkoxysilane, a polyglycerol, a poloxamer, an ethoxylated cetearyl alcohol, a polyethylene glycol diester of stearic acid and combinations thereof.

35. The sprayable antimicrobial coating formulation of claim 33, wherein the antimicrobial agent is a quaternary ammonium compound, a quaternary phosphonium compound, a poly-quaternary ammonium compound, a poly-quaternary phosphonium compound, a polyalkyl guanidinium salt, a polyalkyl guanidine, a polyethyleneimine, or a combination thereof.

36. The sprayable antimicrobial coating formulation of claim 33, wherein the antimicrobial agent is R₄Y⁺X⁻ or (R₄Y⁺X⁻)q, wherein Y is phosphorus or nitrogen; q is a whole number selected from 2-20; R for each instance is independently selected from the group consisting of alkyl, alkenyl, alkynyl, cycloalkyl, aryl, and aralkyl; and X is an anion.

37. The sprayable antimicrobial coating formulation of claim 33, wherein the antimicrobial agent has the Formula 1: 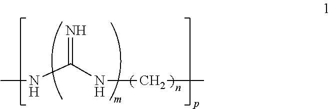
or a conjugate salt thereof, wherein
m is 1, 2, or 3;
n is a whole number selected from 2-12; and
p is a whole number selected from 2-12.

38. The sprayable antimicrobial coating formulation of claim 33, wherein the antimicrobial agent is a polyhexamethylene guanidine (PHMG), a polyhexamethylene biguanidine (PHMB), dimethyloctadecyl[3-(trimethoxysilyl)propyl]ammonium halide, a diallyl dimethyl ammonium halide, a branched polyethylenimine, or a mixture thereof.

39. The sprayable antimicrobial coating formulation of claim 33, wherein the film forming agent is selected from the group consisting of polyvinyl alcohol, polyvinyl pyrrolidone, polyacrylic acid, polyacrylamide, polymethacrylamide, polyethylene oxide, polyalkyl vinyl ether, polyurethane, carboxymethylcellulose, methylcellulose, hydroxypropylcellulose, chitosan, sodium alginate, and mixtures and copolymers thereof.

40. The sprayable antimicrobial coating formulation of claim 33, wherein the film forming agent comprises polyvinyl pyrrolidone.

41. The sprayable antimicrobial coating formulation of claim 33, wherein the antifouling agent is a polyethyleneglycol, an alkyl polyethyleneglycol, an alkoxy polyethyleneglycol, an alkoxy polyethyleneglycol alkyltrialkoxysilane, or a combination thereof; the antimicrobial agent is a quaternary ammonium compound, polyalkyl guanidinium salt, a polyalkyl guanidine, a branched polyethylenimine, or a combination thereof; and the film forming agent is polyvinyl pyrrolidone.

42. The sprayable antimicrobial coating formulation of claim 33, wherein the antifouling agent is an alkyl polyethyleneglycol, an alkoxy polyethyleneglycol alkyltrialkoxysilane, or a combination thereof; the antimicrobial agent is a dimethyloctadecyl[3-(trimethoxysilyl)propyl]ammonium halide, a diallyl dimethyl ammonium halide, polyhexamethylene biguanide, a branched polyethylenimine, or a mixture thereof; and the film forming agent is polyvinyl pyrrolidone.

43. The sprayable antimicrobial coating formulation of claim 33, wherein the antimicrobial agent and the antifouling agent are each independently present in the sprayable antimicrobial coating formulation at a concentration between about 0.1 to about 5 parts per hundred.

44. The sprayable antimicrobial coating formulation of claim 33, wherein the film forming agent is present in the sprayable antimicrobial coating formulation at a concentration between about 0.1 and 5 parts per hundred.

45. The sprayable antimicrobial coating formulation of claim 33, wherein the solvent comprises water, an alcohol, or a mixture thereof.

46. The sprayable antimicrobial coating formulation of claim 33, wherein the antifouling agent is an alkyl polyethyleneglycol, an alkoxy polyethyleneglycol alkyltrialkoxysilane, or a combination thereof; the antimicrobial agent is a dimethyloctadecyl[3-(trimethoxysilyl)propyl]ammonium halide, a diallyl dimethyl ammonium halide, a polyhexamethylene biguanide, a branched polyethylenimine, or a mixture thereof; the film forming agent is polyvinyl pyrrolidone; and the solvent comprises water.
